(19) United States
(12) Patent Application Publication
(10) Pub. No.: US 2017/0242880 A1
(43) Pub. Date: Aug. 24, 2017

(54) B-TREE INDEX STRUCTURE WITH GROUPED INDEX LEAF PAGES AND COMPUTER-IMPLEMENTED METHOD FOR MODIFYING THE SAME

(71) Applicant: Michael A. Barzilli, Encino, CA (US)

(72) Inventor: Michael A. Barzilli, Encino, CA (US)

(21) Appl. No.: 15/048,815

(22) Filed: Feb. 19, 2016

(51) Int. Cl. G06F 17/30

(52) U.S. Cl. CPC G06F 17/30327; G06F 17/30336

(57) ABSTRACT

An improved B-Tree index structure with grouped index leaf pages and computer-implemented method for modifying the same. The improved index may be stored in a B-Tree structure on a data, storage device that may be coupled to a computer, in particular, the improved index may comprise one or more grouped index leaf pages which may store index entries that may be grouped for the same index key value and then later stored as shortened index leaf entries. In addition, a hybrid version of the improved index may be implemented to combine grouped index leaf pages with conventional index leaf pages in a single index. In particular, the intermediate index entries may be extended to store references to both grouped index leaf pages and conventional index leaf pages.

### BACKGROUND

1. Field

The present disclosure relates generally to computer-implemented database index structures, typically found in database software, and, in particular, to B-Tree index structures.

2. Description of Related Art

In general, databases are computerized information storage and retrieval systems and are typically organized into tables, which generally consist of records or rows of data. Tables are usually organized into columns, each of which is preferably used for storing a particular category of information i.e., a data element).

An index is an ordered set of pointers (i.e., references) to the records in a database table and typically provides an alternate technique for accessing records in a table. An index is typically a copy of the original table's data that is built from records based on one or more columns of the table. An index can be used to search for matching records within a table without the need to scan the entire table. An index generally comprises index entries (i.e., index records or index rows), which are usually composed of two types of data: (1) the index key values (i.e., index data) to be searched and (2) the index leaf pointers (i.e., pointers, references, row identifiers, row locators, or ROWIDs) that reference back to the original table's data records. Indexes are also generally useful outside database systems, where the index (rather than containing a copy of the original table's data) simply contains “index data” and index leaf pointers referencing the original “source of the index data”.

The index key values may contain a single column of index data or a plurality of columns of index data (i.e., a composite index). There are many types of indexes such as B-Tree indexes, which are generally the most common. A B-Tree, short for balanced tree, is a hierarchical tree structure that may be used as the storage structure for various types of data. A B-Tree index structure is a storage structure for storing an ordered list of index key values and pointers, the index key values being divided into ranges and stored in a B-Tree hierarchical structure with a corresponding pointer. By searching first on the index key value ranges and then only searching within the targeted ranges that match the search criteria, B-Tree indexes typically provide excellent search performance. Although some indexes utilize a combination of structures (e.g. using a B-Tree structure for only a portion of the index while using another structure, such as a separate list file for other portions of the index), these combination indexes may link to additional external files or additional non-B-Tree storage structures that extend beyond the B-Tree hierarchy. As a result, unrelated files may need to be searched and accessed. Thus, using a B-Tree structure for the entire index is advantageous, as it provides: (1) a consistent approach in accessing the index, (2) uniform search performance regardless of which portion of the index is being searched, and (3) the ability to perform range scans throughout all portions of the index. As such, the present disclosure relates to B-Tree indexes where a B-Tree structure is used for the entire index.

In general, a B-Tree index structure is divided into three levels: the root level, the intermediate level, and the leaf level. The root level of a B-Tree index is the top most portion of the B-Tree structure and generally comprises ranges of index key values along with intermediate index pointers to the intermediate level that relate to said ranges of index key values. The intermediate level of a B-Tree index is optional and is similar to the root level in that it also generally comprises ranges of index key values along with intermediate index pointers to the leaf level that relate to said ranges of index key values. In some indexes, there may be no intermediate level, and the root level may serve the function of the intermediate level. In other indexes, the intermediate level may comprise multiple sub-levels. The leaf level of a B-Tree index is the final level of the hierarchical tree structure and generally comprises index leaf entries. Each index leaf entry is generally one index key value paired with one index leaf pointer that references the original source of the index data. The index leaf level has one and only one index entry for each original source of the index data.

The index entries from each level of the B-Tree index are generally stored in logical order of the index key value and usually stored together as one or more index pages (i.e., index blocks or index chunks). Index pages generally have a configured maximum page size which is typically 4,096 bytes or 8,192 bytes. Using index pages as part of the storage structure is usually advantageous, as it allows data to be stored in smaller chunks, thereby making it easier to re-arrange the index pages when index entries are added or removed. Using index pages may also provide for quicker searches by allowing a search to retrieve only relevant index pages that contain the index entries needed to satisfy a particular search.

The intermediate level of the B-Tree index, when present, generally comprises intermediate index entries, which are typically stored on one or more intermediate index pages (i.e., internal nodes or branch blocks). Each intermediate index entry typically stores the minimum index key value prefix needed to make a branching decision between two index key values. This technique usually enables the index to fit as much data as possible on each intermediate index page. Each intermediate index entry may also store an intermediate index pointer that references the index page that is subordinate to the intermediate index entry in the B-Tree hierarchy.

The leaf level of the B-Tree index generally comprises index leaf entries (i.e., leaf records), which are stored on one or more index leaf pages. Each index leaf entry generally comprises both an index key value and an index leaf pointer that references the original source of the index data. The index leaf pages may store individual index leaf entries for every indexed data value and also a corresponding index leaf pointer (i.e., row identifier) for every indexed data value. Each index leaf page is generally linked to an intermediate index entry that contains an intermediate index pointer that references each said index leaf page. The number of index leaf entries stored on each index leaf page is usually limited by the maximum index leaf page size.

An index that uses a B-Tree structure for the entire index and also uses index pages to store the index entries may be advantageous as it allows for multiple concurrent access and modifications (i.e., adding or removing index entries) to the index. Using the B-Tree structure and index pages generally also allows for each index page to be modified separately and simultaneously. Furthermore, using index pages also generally allows for faster search performance by allowing a search to only retrieve a small subset of index entries that are needed to satisfy a particular search. On the other hand, combination indexes (i.e., indexes that use a combination of B-Tree and non-B-Tree structures) usually create simultaneous modifications that are complicated, as the non-B-Tree structures typically only allow singular access. Non-B-Tree structures of combination indexes are also typically stored as a single file, a postings file, or a postings list which cannot be easily modified to add index entries to the middle portion of the file without modifying the entire file. Accordingly, it would be preferable that the indexes utilize a B-Tree structure for the index and use index pages to store the index entries.

Furthermore, in a B-Tree index, each index leaf entry may have one unique index leaf pointer, which may be a “forward” index or simply an index. Each index leaf pointer also may reference a single unique source of the index data, and each source of the index data is usually contained within the index leaf entries only once. Thus, a forward index, or an index with unique index leaf pointers, is typically advantageous, as it allows for the index to enforce uniqueness of the data if desired. A forward index is also advantageous as it allows for searches that output a unique list of matching index leaf pointers without additional processing due to its unique index leaf pointers. As such, it is also preferable that the indexes utilize forward indexes.

In sum, an index may contain several index entries with the same index key value, each being a single unique index entry with a unique index leaf pointer. For example, a database table that contains one record for each customer including the customer's address may have an index on the customer's city. This example index would contain the index data of customer city and could be used to satisfy searches for customers who live in a particular city. If five records in this table include customers with ‘Los Angeles’ as the customer city, then there would theoretically be five index entries corresponding to those records in the customer table. Each of those five index entries would have the same index key value of ‘Los Angeles’ with unique index leaf pointers. Accordingly, when comparing B-Tree structures utilizing multiple index entries with the same index key value, conventional systems do not provide an optimized index leaf page structure.

Therefore, there is a need in the art for an improved technique for storing B-Tree indexes with grouped index leaf pages.

### SUMMARY OF ILLUSTRATIVE EMBODIMENTS

To overcome the limitations in the prior art and to minimize other limitations that will become apparent upon reading and understanding the present disclosure, the following discloses a method and an apparatus for a B-Tree index with grouped index leaf pages.

One embodiment may be a computer-implemented B-Tree index structure for storing at least one column of index data as a logically ordered set of index entries on a data storage device, comprising: (a) at least one first intermediate index entry, comprising: (i) a first intermediate index key value of one or more columns of index data; and (ii) a first intermediate index pointer; (b) at least one grouped index leaf page, comprising: (i) at least one shortened index leaf entry, having a first grouped index key value of the one or more columns of index data of the at least one shortened index leaf entry selectively extracted; comprising: (1) an index leaf pointer; (2) wherein the index leaf pointer may reference a source of an index data; and (ii) a page header, comprising; (1) a page header index key value of the one or more columns of index data; (2) wherein the page header index key value of the page header may store the extracted first grouped index key value from the at least one shortened index leaf entry; (c) wherein the first intermediate index pointer may reference the at least one grouped index leaf page; and (d) wherein the at least one grouped index leaf page may store a plurality of index leaf pointers that correspond to a plurality of index entries of the same index key value of the one or more columns of index data. The page header may further comprise at least one status means for indicating an index leaf page type of the at least one grouped index leaf page. The at least one shortened index leaf entry may further comprise at least one status means for indicating an index leaf entry type of the at least one shortened index leaf entry. The at least one grouped index leaf page may further comprise: a slot array for storing one or more locations of one or more shortened index leaf entries on the at least one grouped index leaf page, comprising: (i) at least one byte location pointer; and (ii) at least one status means for indicating an index leaf entry type of the at least one shortened index leaf entry; wherein the byte location pointer may reference a location of the shortened index leaf entry on the at least one grouped index leaf page. The at least one first intermediate index entry may further comprise at least one status means for indicating an index leaf page type of the at least one referenced grouped index leaf page. The first intermediate index key value of the at least one first intermediate index entry may comprise: a first segment and a second segment; wherein the first segment may be defined as an index key value prefix and stored in the at least one first intermediate index entry; and wherein the second segment may be absent from the at least one first intermediate index entry. The B-Tree index may be a composite index; wherein the composite index may comprise one or more composite index key values; wherein each of the one or more composite index key values may comprise a plurality of columns of index data; and wherein each column of the plurality of index data may store a category of information. The B-Tree index structure may further comprise: (a) at least one second intermediate index entry comprising: (i) a second intermediate index key value of the one or more columns of index data; and (ii) a second intermediate index pointer; (b) at least one conventional index leaf page, comprising: (i) at least one conventional index leaf entry, comprising: (1) a conventional index key value of the one or more columns of the index data; and (2) a conventional index leaf pointer; wherein the conventional index leaf pointer may reference a source of the index data; (3) wherein the second intermediate index pointer may reference the at least one conventional index leaf page. The at least one shortened index leaf entry may be a partially shortened index leaf entry, further comprising: a partially shortened index key value of the one or more columns of index data. The B-Tree index may be a composite index; wherein the composite index may comprise one or more composite index key values; wherein each of the one or more composite index key values may comprise the one or more columns of index data; wherein each of the one or more columns of index data may store a category of information. The at least one shortened index leaf entry may be a partially shortened index leaf entry, comprising: a partially shortened index key value of the one or more columns of the index data.

Another embodiment may be a computer-implemented B-Tree index structure for storing at least one column of index data as a logically ordered set of index entries on a data storage device, comprising: (a) at least one first intermediate index entry comprising; (i) a first intermediate index key value of one or more columns of an index data; and (ii) a first intermediate index pointer; (b) at least one grouped index leaf page comprising: (i) at least one shortened index leaf entry, having a grouped index key value of the one or more columns of index data of the shortened index leaf entry extracted, comprising; (1) an index leaf pointer; (2) wherein the index leaf pointer references a source of the index data; (c) wherein the at least one first intermediate index entry may store the extracted group index key value from the at least one shortened index leaf entry, and the at least one grouped index leaf page may store a plurality of index leaf pointers that correspond to a plurality of index entries of the same index key value of the one or more columns of the index data; and (d) wherein the first intermediate index pointer may reference the at least one grouped index leaf page. The at least one grouped index leaf page may further comprise: a page header, comprising: at least one status means for indicating an index leaf page type of the at least one grouped index leaf page. The at least one shortened index leaf entry may further comprise: at least one status means for indicating an index leaf entry type of the at least one shortened index leaf entry. The at least one grouped index leaf page may further comprise: a slot array for storing one or more locations of one or more shortened index leaf entries on the at least one grouped index leaf page, comprising: (i) at least one byte location pointer; and (ii) at least one status means for indicating an index leaf entry type of the at least one shortened index leaf entry; and (iii) wherein the byte location pointer references a location of the at least one shortened index leaf entry on the at least one grouped index leaf page. The at least one first intermediate index entry may further comprise: at least one status means for indicating an index leaf page type of the at least one referenced grouped index leaf page. The B-Tree index may be a composite index; wherein the composite index may comprise one or more composite index key values; wherein each the one or more composite index key values may comprise a plurality of columns of the index data; wherein each of the plurality of columns of the index data may store a category of information. The B-Tree index structure may further comprise: (a) at least one second intermediate index entry comprising: (i) a second intermediate index key value of one or more columns of the index data; and (ii) a second intermediate index pointer; and (iii) wherein the second intermediate index pointer references one conventional index leaf page; (b) at least one conventional index leaf page, comprising; at least one conventional index leaf entry, comprising; (i) a conventional index key value of the one or more columns of the index data; and (ii) a conventional index leaf pointer; and (iii) wherein the conventional index leaf pointer references a source of the index data. The at least one shortened index leaf entry may be a partially shortened index leaf entry, further comprising: a partially shortened index key value of the one or more columns of the index data.

Another embodiment may be a method of modifying a computer-implemented B-Tree index, comprising the steps of: (1) scanning one or more intermediate index pages for a first intermediate index entry greater than or equal to a new index entry; (2) comparing the first intermediate index entry to the new index entry for equality; (3) comparing a second intermediate index entry to the new index entry for equality to determine whether an index leaf page type is a grouped index leaf page; (4) fetching an index leaf page from an intermediate index pointer of the first intermediate index entry and adding or removing an index leaf pointer of the new index entry; (5) determining whether the index leaf pointer of the new index entry will fit on the index leaf page; (6) splitting the index leaf page into two grouped index leaf pages of unequal size; (7) setting the second intermediate index entry to the first intermediate index entry; (8) determining the index leaf page type to be a conventional index leaf page type, and return to a main process; (9) fetching the index leaf page from the intermediate index pointer of the first intermediate index entry, and adding or removing the index key value of the new index entry and the index leaf pointer to a leaf page; (10) determining whether the new index entry will fit on the index leaf page without exceeding the selected maximum index leaf page size; (11) determine if a position of the new index entry on the index leaf page is less than or equal to fifty percent of a selected maximum index leaf page size; (12) splitting the index leaf page into two conventional index leaf pages; (13) comparing the new index entry to a final entry on the index leaf page; and (14) splitting the index leaf page into two index leaf pages with the index leaf page remaining a conventional index leaf page type and the new index leaf page built as a grouped index leaf page type.

In accordance with the present disclosure, an index may be stored in a B-Tree structure, which may be stored in a data storage device that is coupled to a computer. In particular, the present specification discloses an improved index which may comprise one or more grouped index leaf pages which may store index entries that are grouped for the same index key value and then stored together as shortened index leaf entries.

Another embodiment, which may be a hybrid version of the improved index, is also disclosed herein. The hybrid version of the improved index may combine grouped index leaf pages and conventional index leaf pages as part of the same B-Tree index structure. The hybrid version of the improved index may also extend the intermediate index entries to store references to both grouped index leaf pages and conventional index leaf pages.

In addition, a version of the improved index for composite indexes is also disclosed. The composite version of the improved index combines partially grouped index leaf pages, grouped index leaf pages, and conventional index leaf pages as part of the same B-Tree index structure.

It is an object to provide an improved B-Tree index structure that may be more compact and may consume less storage space on the data storage device when there are multiple index entries with the same index key value in the B-Tree index. Providing an improved B-Tree index that consumes less storage space is generally advantageous as it usually results with reduced data storage costs and quicker search and retrieval functions. It is also an object to provide a flexible hybrid index that combines grouped index leaf pages with conventional index leaf pages for backward compatibility.

It is an object to provide an improved B-Tree index structure that comprises index key values containing a single column of index data or a plurality of columns of index data (i.e., a composite index).

### BRIEF DESCRIPTION OF THE DRAWINGS

The drawings show illustrative embodiments, but do not depict all embodiments. Other embodiments may be used in addition to or instead of the illustrative embodiments. Details that may be apparent or unnecessary may be omitted for the purpose of saving space or for more effective illustrations. Some embodiments may be practiced with additional components or steps and/or without some or all components or steps provided in the illustrations. When different drawings contain the same numeral, that numeral refers to the same or similar components or steps.

FIG. 1 is an illustration of an exemplary computer hardware environment that may be used in accordance with the present disclosure.

FIG. 2 is an illustration of index leaf entries of a conventional B-Tree index.

FIG. 3 is an illustration of index leaf entries of one embodiment of an improved B-Tree index with grouped index leaf pages according to the present disclosure.

FIG. 4 is an illustration of the index leaf page structure of a conventional B-Tree index.

FIG. 5 is an illustration of grouped index leaf page structure of one embodiment of an improved hybrid B-Tree index according to the present disclosure.

FIG. 6 is an illustration of a grouped index leaf page structure of one embodiment of an improved hybrid B-Tree index for a composite index (an index that may comprise a plurality of columns of index data) according to the present disclosure.

FIG. 7 is an illustration of an exploded view of a conventional index leaf page.

FIG. 8 is an illustration of an exploded view of one embodiment of an improved index leaf page with an improved page header according to the present disclosure.

FIG. 9 is an illustration of an exploded view of one embodiment of an improved index leaf page with an improved intermediate index entry according to the present disclosure.

FIG. 10 is a flow chart of one embodiment of a method of modifying an improved hybrid B-Tree index in accordance with the present disclosures.

### DETAILED DESCRIPTION OF ILLUSTRATIVE EMBODIMENTS

In the following detailed description, numerous specific details are set forth in order to provide a thorough understanding of various aspects of the embodiments, which stay be operative in a computer environment. These embodiments, however, are not limited to any particular application or environment. Instead, those skilled in the art will find that the embodiments may be advantageously applied to any computer application or computer environment requiring indexes, page structures, computer storage, including non-SQL database management systems, word processors (e.g., indexed spell checkers), spreadsheets, and the like.

While some embodiments are disclosed herein, other embodiments will become obvious to those skilled in the art as a result of the following detailed description. The following embodiments are capable of modifications of various obvious aspects, all without departing from the spirit and scope of protection. The Figures, and their detailed descriptions, are to be regarded as illustrative in nature and not restrictive. Also, the reference or non-reference to a particular embodiment shall not be interpreted to limit the scope of protection.

Further, those skilled in the art will find that these embodiments may be advantageously applied to B-Tree alternatives other than the “basic” B-Trees described by Bayer and McCreight in 1972. Variants include, for instance, B+-Trees, Prefix B+-Trees, Virtual B-Trees, and Binary B-Trees. The description of the exemplary embodiment which follows is, therefore, for the purpose of illustration and not limitation.

In some embodiments, optionally, each index page may contain a page header of general information regarding the index page. The page header, for instance, may include the ID of the object that the index page belongs to, the amount of free space available on the index page, the page number, and other information related to the index page. As new index entries are added to an index page, the amount of space used for storing the index entries on the index page increases while the size of the page header remains the same.

In the following description of the preferred embodiment, reference is made to the accompanying drawings which form a part hereof, and which is shown by way of illustration via embodiments. It is to be understood that other embodiments may be utilized as structural changes may be made without departing from the scope of the present disclosure.

### Definitions

In the following description, certain terminology is used to describe certain features of the following embodiments. For example, as used herein, the terms “computer” and “computer system” generally refer to any device that processes information with an integrated circuit chip.

As used herein, the terms “software” and “application” refer to any set of machine-readable instructions on a machine, web interface, and/or computer system that directs a computer's processor to perform specific steps, processes, or operations disclosed herein. The application or software may comprise one or more modules that direct the operation of the computer system on how to perform the disclosed method.

As used herein, the term “computer-readable” medium may refer to any storage medium adapted to store data and/or instructions that are executable by a processor of a computer system. The computer-readable storage medium may be a computer-readable non-transitory storage medium and/or any non-transitory data storage circuitry (e.g., buggers, cache, and queues) within transceivers of transitory signals. The computer-readable storage medium may also be any tangible computer readable medium. In various embodiments, a computer readable storage medium may also be able to store data, which is able to be accessed by the processor of the computer system.

As used herein, the term “columns of index data” refers to logical columns indicating logically organized and indexable data elements of a particular category of information without any requirement for physical columniation. A composite index is simply an index that contains more than one column of index data. As used herein, the term “index key value” refers to all the columns of index data for a single index entry while not including the pointers.

As used herein, the term “page header” refers to all portions of an index page which: (1) remain constant in size regardless of the number of index entries on said index page; (2) without any requirement for the size of said page header to be exactly the same for every index page; and (3) without any requirement for said page header to be in a single location on the index page.

### Hardware Environment

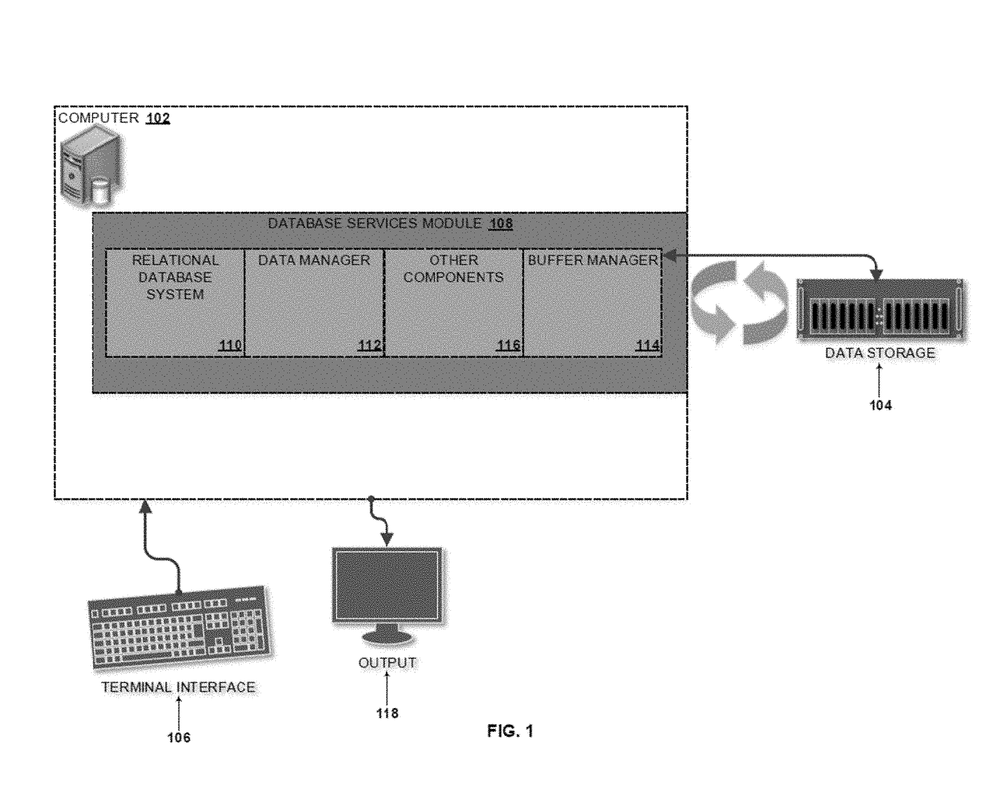

FIG. 1 is an illustration of an exemplary computer hardware environment that may be used in accordance with the present disclosure. In the exemplary environment, a computer system 102 may comprise at least one computer processor electronically coupled to at least one data storage device 104, which may be a computer-readable medium such as a fixed or hard disk drive, a CDROM drive, a tape drive, or other device that stores at least one database.

Operators of the computer system 102 may use a standard operator interface 106 or other similar interface, to input and transmit electrical signals to the computer system 102 that represent commands for performing various search and retrieval functions (e.g., queries) against the databases. These queries may invoke functions performed by a relational database system software 110.

Within the computer system 102 may be the database services module 108. The database services module 108 may comprise several submodules including the relational database system 110, a data manager 112, a buffer manager 114, and other components 116 such as a compiler/interpreter.

The embodiments may be implemented using computer commands executed under the control of the database services module 108. The database services module 108 may receive the commands which may be inputted interactively into the computer system 102 by a user or operator sitting at an output interface 118 via operator interface 106. Based on the operator's commands, the database services module 108 may then store and retrieve data and index pages from the data storage device 104. The database services module 108 may then read or modify data from the index pages and then may write the modified data and index pages to the data storage device 104.

Those skilled in the art will recognize that the exemplary environment illustrated in Ha 1 is not intended to limit the embodiments. Indeed, those skilled in the art will recognize that other alternative hardware and software environments may be used without departing from the scope of protection.

Thus, the embodiments may be implemented using standard programming and/or engineering techniques to produce software, firmware, hardware, or any combination thereof. The embodiments may be present within any computer system.

### Exemplary B-Tree Index with Conventional Index Leaf Entries

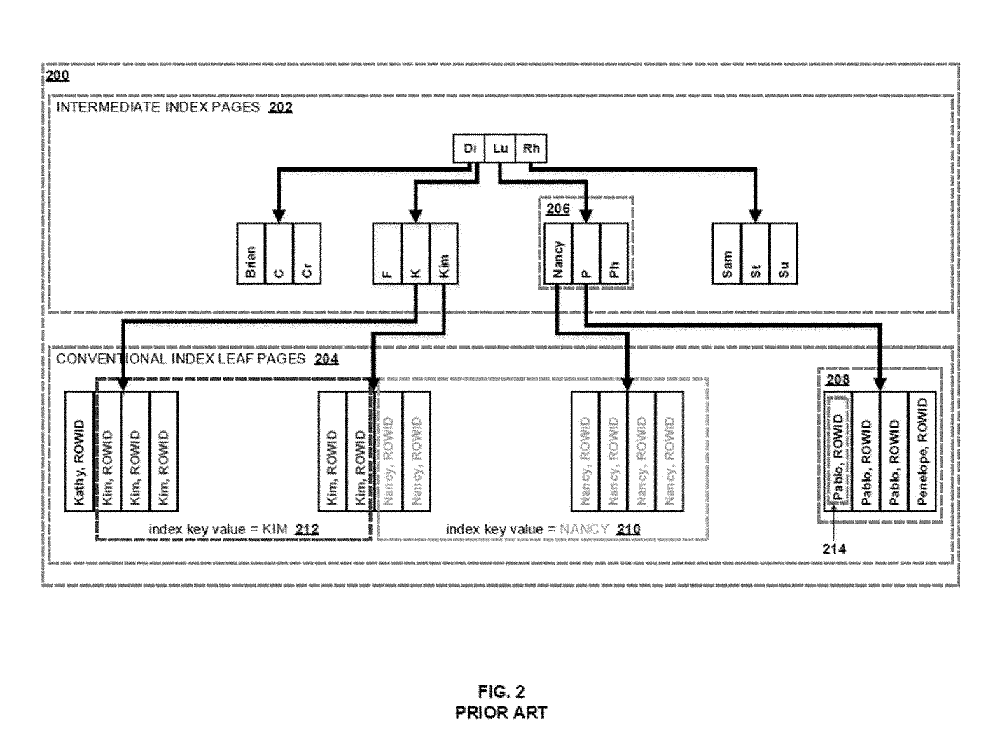

FIG. 2 is an illustration of an exemplary B-Tree index with conventional index leaf entries. In this B-Tree index 200, ‘First Name’ is the index key value and ‘ROWID’ is the index leaf pointer. This index 200 could be used to satisfy searches that search for matching index entries for a particular ‘First Name’.

FIG. 2 also shows that the index 200 includes at least one intermediate index page (i.e., branch block) 206 and at least one conventional index leaf page (i.e., leaf block) 208. Each of the intermediate index pages 202 includes at least one intermediate index entry. Each intermediate index entry stores the index key value (or a minimum index key value prefix) and an intermediate index pointer that references a conventional index leaf page. In the intermediate index page 206, some intermediate index entries store the full index key value (e.g., ‘Nancy’), and other intermediate index entries store a prefix (e.g., ‘P’).

Each of the conventional index leaf pages 204 includes at least one conventional index leaf entry 214. Each conventional index leaf entry 214 stores an index key value and a corresponding index leaf pointer for locating the original source of the index data for said conventional index leaf entry 214. The sum of the conventional index leaf entries contain index key values and index leaf pointers that correspond to every index entry present in the index 200. In the conventional index leaf pages 204, each conventional index leaf entry 214 stores an index key value (e.g., ‘Pablo’). In the conventional index leaf pages 204, each conventional index leaf entry 214 also stores an index leaf pointer (e.g., ‘ROWID’).

In the B-Tree index 200, the conventional index leaf entries for the index key value of ‘Nancy’ 210, for example, are stored on multiple conventional index leaf pages. Similarly, the conventional index leaf entries for the index key value of ‘Kim’ 212 are also stored on multiple conventional index leaf pages. Each of the conventional index leaf pages 204 may contain multiple conventional index leaf entries for dissimilar index key values.

### Improved B-Tree Index Shortened Index Leaf Entries

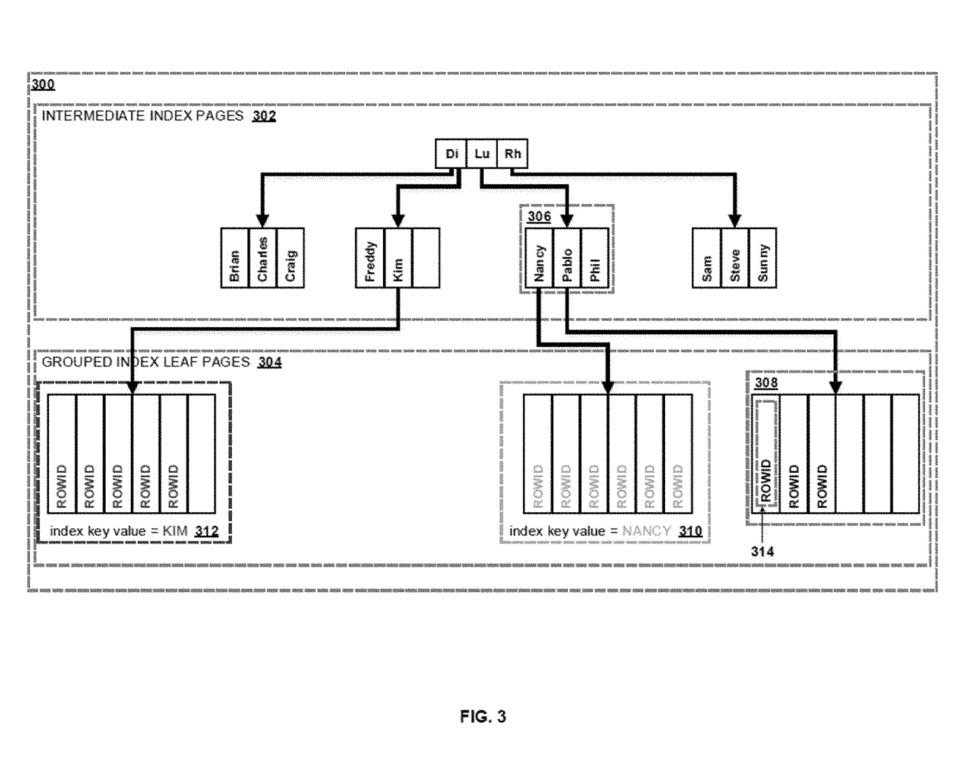

FIG. 3 is an illustration of one embodiment of an improved B-Tree index with shortened index leaf entries according to the present disclosure. As shown in FIG. 3, the improved B-Tree index 300 may comprise at least one intermediate index page 306 and at least one grouped index leaf page 308. Each of the intermediate index pages 302 may comprise at least one intermediate index entry. Each intermediate index entry may store an index key value and an intermediate index pointer that references a grouped index leaf page.

Each of the grouped index leaf pages 304 may comprise at least one shortened index leaf entry 314. Each shortened index leaf entry 314 may store index leaf pointers for locating the original source of the index data. The grouped index leaf pages 304 may each store shortened index leaf entries, and the sum of the shortened index leaf entries may contain index leaf pointers that correspond to every index entry present in the index 300. The index entries stored on any particular grouped index leaf page 304 may be index entries with the same index key value that are grouped together. The index key value may be extracted from the index leaf entries, and then later stored absent said index key value as shortened index leaf entries. In the grouped index leaf page 308, the shortened index leaf entries may store index leaf pointers such as, for example ‘ROWID’.

FIG. 3 also shows that the shortened index leaf entries for the index key value of ‘Nancy’ 310 of the improved B-Tree index 300, for example, may be stored on a single grouped index leaf page. Similarly, the shortened index leaf entries for the index key value of ‘Kim’ 312 may also be stored on a single grouped index leaf page. Each grouped index leaf page 304 thus may contain index leaf pointers for a single index key value.

In one embodiment, the intermediate index entries may extend to store the full index key value (not just the minimum index key value prefix), and said index key value may be absent from the grouped index leaf pages 304. In this embodiment, on the intermediate index page 306, each intermediate index entry may store the full index key value, such as, for example ‘Pablo’. Other suitable embodiments may also exist, including those that do not store the full index key value in the intermediate index entries, but instead, modify the page header of the grouped index leaf pages 304 to store the index key value only once. In one such suitable embodiment, the logical page header of the grouped index leaf pages 304 may be extended to store the extracted index key value, but may not consume the exact same physical location and size on each grouped index leaf page 304. The other suitable embodiments may also be compatible with indexes where the intermediate index entries have prefixes rather than the full index key value.

### Conventional B-Tree Index Leaf Page Structure

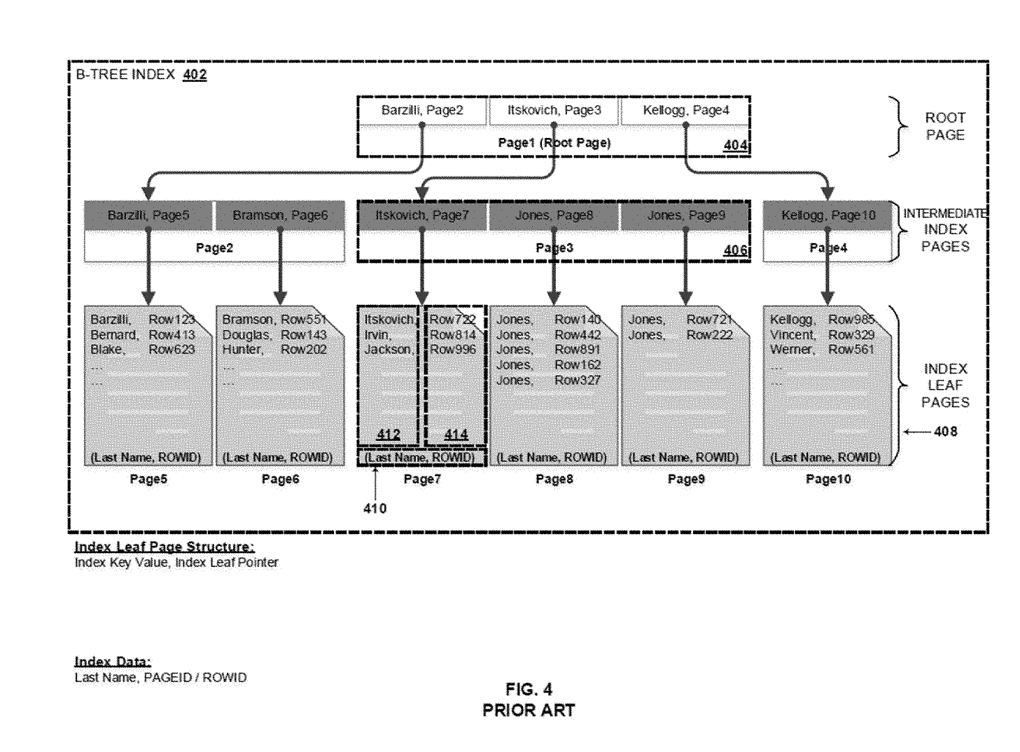

FIG. 4 is an illustration of a conventional B-Tree index leaf page structure. As shown in Ha 4, in the conventional B-Tree index 402, ‘Last Name’ is the index key value and ‘ROWID’ is the index leaf pointer to the original source of the index data. This index 402 could be used to satisfy searches that search for matching index entries for a particular ‘Last Name’. In this B-Tree index leaf page structure, a B-Tree index 402 includes at least one root index page 404, zero or more intermediate index pages 406, and at least one conventional index leaf page 408. When no intermediate index pages are present, the root index page 404 serves the function of the intermediate index pages 406. In the exemplary B-Tree index 402, all conventional index leaf pages 408 include the same page structure 410. The conventional index leaf page structure 410 also includes both index key values 412 and index leaf pointers 414.

### Improved Hybrid B-Tree Index Leaf Page Structure

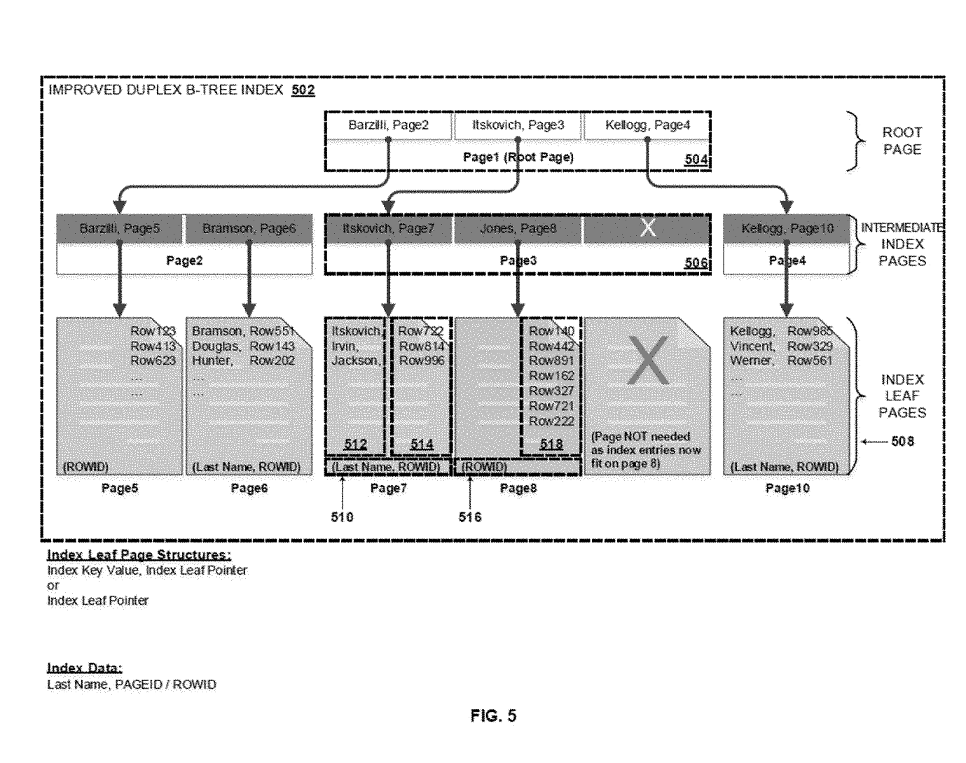

FIG. 5 is an illustration of one embodiment of an improved hybrid B-Tree index leaf page structure according to the present disclosure. As shown in FIG. 5, one embodiment of the improved hybrid. B-Tree index leaf page structure 502 may be a B-Tree index comprising: at least one root index page 504, zero or more intermediate index pages 506, and a plurality of index leaf pages 508. When no intermediate index pages are present, the root index page 504 may serve the function of the intermediate index pages. In the improved hybrid B-Tree index 502, index leaf pages 508 may be structured with two different page structures—i.e., a conventional index leaf page structure 510 and a grouped index leaf page structure 516. The improved hybrid. B-Tree index 502 may comprise both conventional index leaf pages and grouped index leaf pages. The conventional index leaf page structure 510 may comprise both index key values 512 and index leaf pointers 514.

As discussed, above in FIG. 5, the grouped index leaf page structure 516 may comprise index leaf pointers 518. The index entries stored on a grouped index leaf page may be index entries with the same index key value that are grouped together. The index key value may be extracted from the index leaf entries, and then may be stored absent said index key value as shortened index leaf entries. The index leaf pages 508 may be the index leaf page type of either a grouped index leaf page or a conventional index leaf page. The index leaf entries may be the index leaf entry type of either a shortened index leaf entry or a conventional index leaf entry.

The improved hybrid index structure 502 may comprise a mix of conventional index leaf pages and grouped index leaf pages. The intermediate index entries may be extended to store references to said grouped index leaf pages and said conventional index leaf pages.

In another embodiment, index leaf pages that contain greater than fifty percent of the index leaf entries for the same index key value may be structured as a grouped index leaf page with any dissimilar index leaf entries moved to another index leaf page. Additionally, in this embodiment, the grouped index leaf pages also might not contain the index key value, not in the page header of the index leaf page, nor in any type of compression dictionary for the index leaf page. Moreover, in this embodiment, the index key value that each grouped index leaf page represents may be entirely derived from the intermediate index entries. There may also other suitable embodiments including modifying the pale header of the grouped index leaf pages to store the index key value only once.

Existing compression technologies typically function by adding a compression dictionary, an anchor record, or a compression information (CI) structure to the index leaf page. The compression dictionary may contain the decompressed values that will be represented as compressed “symbols” in one or more index leaf entries. Each index leaf entry may also be extended to add a column descriptor (CD) array that adds typically 4 bits in size for each column of index data in the index leaf entry. On each index leaf entry, the 4 bits of additional storage for the column descriptor for each column of index data may be required to represent the length of each column and whether each column contains a symbol representing a decompressed value that has been moved to the compression dictionary. Each column of index data in a given index entry, having a value to be compressed, may be replaced with a symbol, typically 1 byte (8 bits) in size, representing the corresponding decompressed value that was moved to the compression dictionary.

The embodiments disclosed herein contrasts existing compression technologies in that the present invention does not add the 4 bits per column for the column descriptor, nor does the embodiments add the 1 byte per column for the compression symbol. These embodiments typically require no symbols, placeholders, or pointers in each index entry to represent the decompressed values in any such compression dictionary. Existing compression technologies also require that the index leaf entry be decompressed before any comparisons or operations can be performed on it. The embodiments disclosed herein require no decompression and allows comparisons and other operations on the index leaf page to occur immediately.

The embodiments also generally support several methods for detecting which index leaf pages are of the grouped index leaf page type. For example, the embodiments may modify the page header of each index leaf page to specify whether the index leaf page is a grouped index leaf page or a conventional index leaf page. Alternatively, the embodiments may extend each intermediate index entry to specify whether the intermediate index entry references a grouped index leaf page or a conventional index leaf page.

### Improved Hybrid Composite B-Tree Index Leaf Page Structure

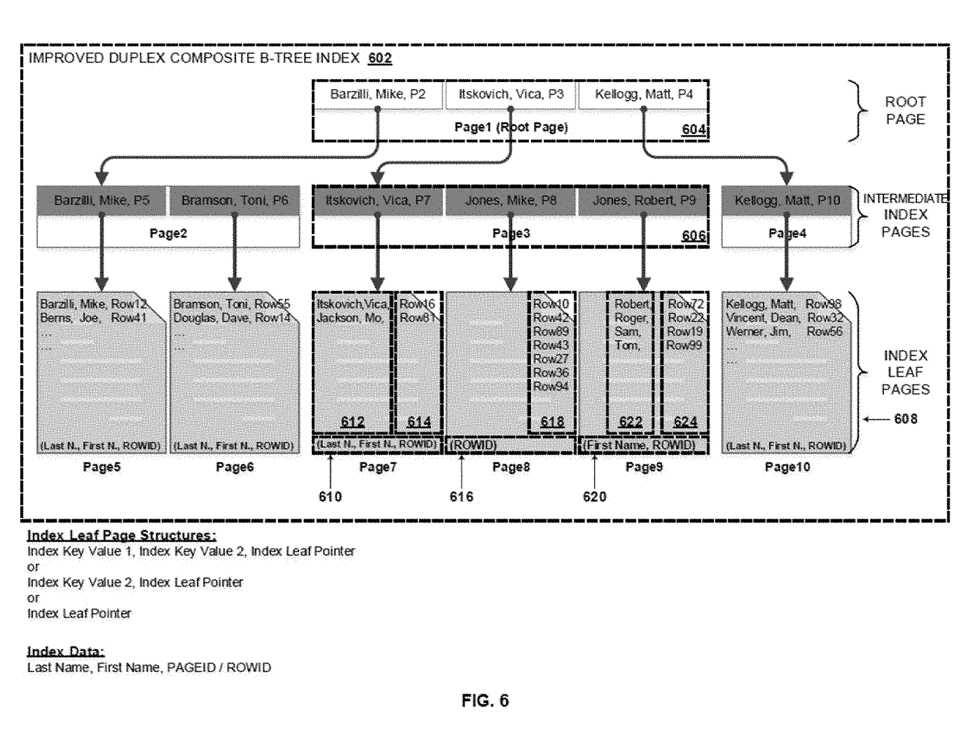

The improved B-Tree structure may also extend to composite indexes index that generally comprises a plurality of columns of index data). FIG. 6 is an illustration of one embodiment of an improved hybrid composite B-Tree index leaf page structure according to the present disclosure. In the improved hybrid composite B-Tree index leaf page structure shown in FIG. 6, there may be two columns of index data i.e., ‘Last Name’ as the first column of index data and ‘First Name’ as the second column of index data. In the improved hybrid composite B-Tree index leaf page structure 602, a B-Tree index may comprise at least one root index page 604, zero or more intermediate index pages 606, and a plurality of index leaf pages 608. When no intermediate index pages are present, the root index page 604 may serve the function of the intermediate index pages. In the improved hybrid composite. B-Tree index 602, index leaf pages 608 are structured with three different page structures—i.e., conventional index leaf page structure 610, partially grouped index leaf page structure 620, and grouped index leaf page structure 616. The improved hybrid composite B-Tree index 602 may comprise conventional index leaf pages, partially grouped index leaf pages, and grouped index leaf pages. The conventional index leaf page structure 610 may comprise both index key values 612 and index leaf pointers 614.

The partially grouped index leaf page structure 620 may comprise a second column's index key values 622 and index leaf pointers 624, which together may form a partially shortened index leaf entry and may be then stored absent the first column's index key values. The index entries stored on a partially grouped index leaf page may be index entries with the same index key value for only some of the columns of index data that are grouped together. Some of the columns of the index key value may be extracted from the index leaf entries, and then stored absent said columns of the index key value as partially shortened index leaf entries. The partially grouped index leaf page structure 620 may be for index leaf pages where all index entries on the index leaf page represent the same index key value for the first portion of columns of index data. All index entries on the index leaf page may also have dissimilar index key values for the second portion of columns of index data. The grouped index leaf page structure 616 may comprise index leaf pointers 618 which may be stored absent any index key values. The grouped index leaf page structure 616 may be for index leaf pages where all index entries on the index leaf page represent the same index key value for all columns of index data.

The improved hybrid composite index may comprise a mix of conventional index leaf pages, partially grouped index leaf pages, and grouped index leaf pages. The intermediate index entries may be extended to store references to said conventional index leaf pages, said partially grouped index leaf pages, and said grouped index leaf pages. Those skilled in the art may recognize that the improved hybrid B-Tree index structure may be extended to indexes with an unlimited number of columns of index data.

### Exploded View of Conventional Index Leaf Page

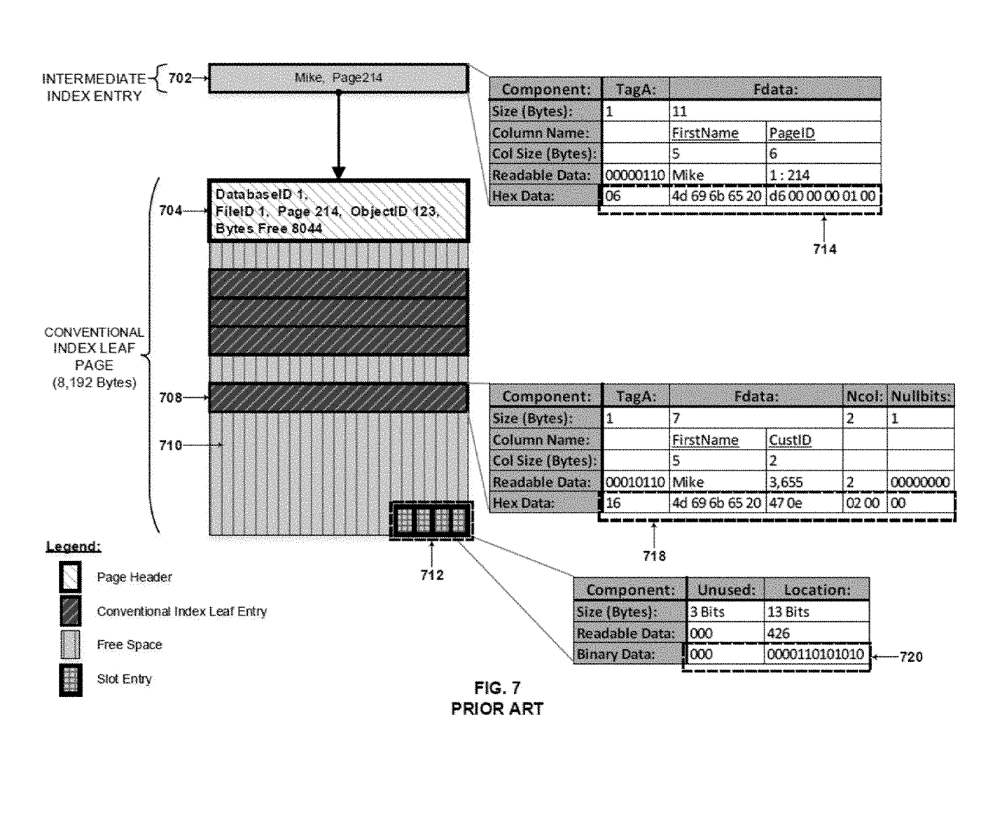

FIG. 7 is an illustration of an exploded view of a conventional index leaf page of a B-Tree index named ‘ix_Customer_FirstName’. In the exploded view of the conventional index leaf page shown in FIG. 7, the column ‘FirstName’ is the index key value and ‘CustID’ (abbreviation for CustomerID) is the index leaf pointer to the original source of the index data. The B-Tree index ‘ix_Customer_FirstName’ includes a single column of index data, ‘FirstName’, with the source of the index data being a database table named ‘Customer’. The ‘Customer’ table has a column ‘FirstName’ that is defined as a fixed-length CHAR(5) NOT NULL data type column. The ‘Customer’ table has another column ‘CustID’ that is defined as a fixed-length SMALLINT(2) NOT NULL CLUSTERED PRIMARY KEY data type. The index ‘ix_Customer_FirstName’ is defined as not allowing NULLs, not having any variable-length columns, and not having any versioning information stored.

FIG. 7 shows that the exemplary B-Tree index could be used to satisfy searches that search for matching index entries for a particular ‘FirstName’.

FIG. 7 also shows that, in the exemplary B-Tree index, the B-Tree index includes at least one intermediate index entry 702 and at least one conventional index leaf page having a size of 8,192 bytes.

The intermediate index entry 702 includes several components including a TagA component, a Fdata component, and optionally other components. The intermediate index entry 702 may include optional additional components such as an additional “uniquifier” column of index data for uniquely identifying intermediate index entries, a number of columns component (Ncol) for determining the number of columns in the index entry, a null bits (Nullbits) component for determining the columns that contain NULLs, a variable block component for variable-length data, a versioning component for tracking data changes to the index entry, and other components. These optional components are not described in detail as the present disclosure provides no improvements to them.

The TagA (i.e., Status Bits A) component of the intermediate index entry 702 is 1 byte in size and stores various statuses of the intermediate index entry 702. TagA component provides a “status means” for determining various statuses.

The Fdata component of the intermediate index entry 702 has a size that is the sum of the size of all the fixed-length columns for the index entry, and it stores the fixed-length columns of the index entry. The Fdata component varies in size depending on how many index columns are fixed-length data types and the defined size of each fixed-length column. In the B-Tree index illustrated in FIG. 7, the Fdata component of the intermediate index entry 702 is 11 bytes in size. The intermediate index entry 702 is stored as HEX format in little-endian encoding 714 (white space is for illustration only) on the data storage device.

Additionally, in the exemplary B-Tree index shown in FIG. 7, the index leaf page includes one page header 704 having a size of 96 bytes, at least one index leaf entry 708, optionally some free space 710, and optionally a slot array 712.

The index leaf entry 708 includes several components including a TagA component, a Fdata component, and optionally other components. The index leaf entry 708 includes columns of index data for both the index key values, ‘FirstName’, and the index leaf pointer ‘CustID’.

The TagA component of the index leaf entry 708 is 1 byte in size and stores various statuses of the index leaf entry 708.

The Fdata component of the index leaf entry 708 has a size that is the sum of the size of all the fixed-length columns for the index entry, and it stores the fixed-length columns of the index entry. The Fdata component varies in size depending on how many index columns are fixed-length data types and the defined size of each fixed-length column. In this B-Tree index shown in FIG. 7, the Fdata component of the index leaf entry 708 is 7 bytes in size. The index leaf entry 708 is stored as HEX format in little-endian encoding 718 (white space is for illustration only) on the data storage device. (Note: the HEX data shown changes as the index key values or index leaf pointers are changed).

The slot array (i.e. record offset table) 712 contains one slot entry for each index leaf entry on the index leaf page. The slot array 712 tracks the location and logical order of all the index leaf entries on the index leaf page and is organized in reverse order, starting from the end of the index leaf page, with the last slot entry referencing the location of the logical first index leaf entry. Each slot entry is 2 bytes in size and stores the byte location pointer of the corresponding index leaf entry on the index leaf page. The byte location pointer is a 2 byte reference to the exact location on the index leaf page for the corresponding index leaf entry. Each slot entry has a size of 2 full bytes even though the valid possible values only require the last 13 bits of each slot entry (1 byte=8 bits). The slot entries are stored in HEX format in little-endian encoding on the data storage device, shown in FIG. 7 as binary data in big-endian encoding 720 (white space is for illustration only). Regarding the slot entry 720, the binary data shown in FIG. 7 is stored as the HEX data ‘AA01’.

### Exploded View of a Grouped Index Leaf Page with Improved Page Header

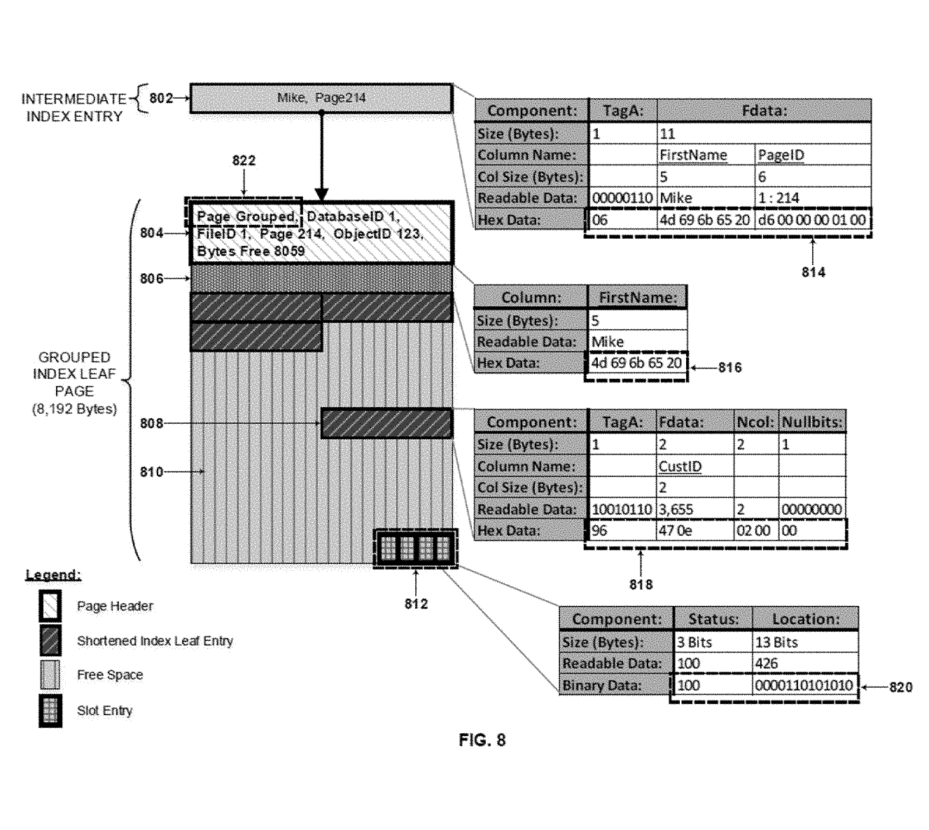

FIG. 8 is an illustration of an exploded view of one embodiment of a grouped index leaf page with an improved page header according to the present disclosure. As shown in FIG. 8, one embodiment of a grouped index leaf page may comprise the column ‘FirstName’ as the index key value and ‘CustID’ as the index leaf pointer. The improved B-Tree index in FIG. 8 may be defined as not allowing NULLs, not having any variable-length columns, and not having any versioning information stored.

The improved B-Tree index illustrated in FIG. 8 may comprise at least one intermediate index entry 802 and at least one grouped index leaf page having a size of 8,192 bytes.

The intermediate index entry 802 may comprise several components including a TagA component, a Fdata component, and optionally other components. The intermediate index entry 802 may also comprise optional additional components.

The TagA component of the intermediate index entry 802 may be 1 byte in size. The TagA component may also provide a status means for determining various statuses of the intermediate index entry 802.

The Fdata component of the intermediate index entry 802 may have a size that is the sum of the size of all the fixed-length columns for the index entry, and it may store the fixed-length columns of the index entry. In the grouped index leaf page of the improved B-Tree index shown in FIG. 8, the Fdata component of the intermediate index entry 802 may be 11 bytes in size. The intermediate index entry 802 may be stored as HEX format in little-endian encoding 814 (white space is for illustration only) on the data storage device.

In the grouped index leaf page of the improved B-Tree index illustrated in FIG. 8, the grouped index leaf page may comprise one page header 804 having a size of 96 bytes, an extended page header component 806, at least one shortened index leaf entry 808, optionally some free space 810, and optionally an improved slot array 812.

In an embodiment, the page header 804 may be an improved page header with an extended page header component 806 that may be extended to include the extracted index key value from the shortened index leaf entries. The page header 804 may also extended to include a status means 822 for determining the index leaf page type of the grouped index leaf page.

The shortened index leaf entry 808 may comprise several components including a TagA component, a Fdata component, and optionally other components. In an embodiment, the shortened index leaf entry 808 may comprise the index leaf pointer, which may be ‘CustID’ in this improved index.

Still, in another embodiment, the TagA component of the shortened index leaf entry 808 may be 1 byte in size and may store various statuses of the shortened index leaf entry 808. The TagA component may provide a status means for determining various statuses and for determining the type of index leaf entry. The TagA component of the shortened index leaf entry 808 may be an improved TagA component that is extended to include a 1 bit status for determining the index leaf entry type of the shortened index leaf entry 808. In FIG. 8, the TagA component of the shortened index leaf entry 808 may have been modified from ‘00010110’ to ‘10010110’ with the first bit indicating the index leaf entry 808 is of the shortened index leaf entry type.

In this embodiment, the Fdata component of the shortened index leaf entry 808 may have a size that is the sum of the size of all the fixed-length columns of the index leaf pointer, and it may store the fixed-length columns of the index leaf pointer. The Fdata component of the shortened index leaf entry 808 may vary in size depending on: (1) how many columns of the index leaf pointer are fixed-length data types and (2) the defined size of each fixed-length column of the index leaf pointer. In the grouped index leaf page of the improved B-Tree index illustrated in FIG. 8, the Fdata component of the shortened index leaf entry 808 may be 2 bytes in size. The shortened index leaf entry 808 may be stored as HEX format in little-endian encoding 818 (white space is for illustration only) on the data storage device.

The slot array 812 may contain one slot entry for each shortened index leaf entry on the grouped index leaf page. The slot array 812 may track the location and logical order of all the shortened index leaf entries on the grouped index leaf page. The slot array 812 may be an improved slot array that is extended to include a 1 bit status on each slot entry for determining the index leaf entry type of each shortened index leaf entry that the slot entry references. In FIG. 8, for example, the last slot entry has been modified from ‘0000000110101010’ to ‘1000000110101010’ with the first bit indicating that the index leaf entry at the page location ‘426’ is of the shortened index leaf entry type. The slot entries may be stored as HEX format in little-endian encoding on the data storage device, shown in FIG. 8 as binary data in big-endian encoding 820 (white space is for illustration only). For the slot entry 820, the binary data shown in FIG. 8 may be stored as the HEX data ‘AA81’

### Exploded View of a Grouped Index Leaf Page with Improved Intermediate Index Entry

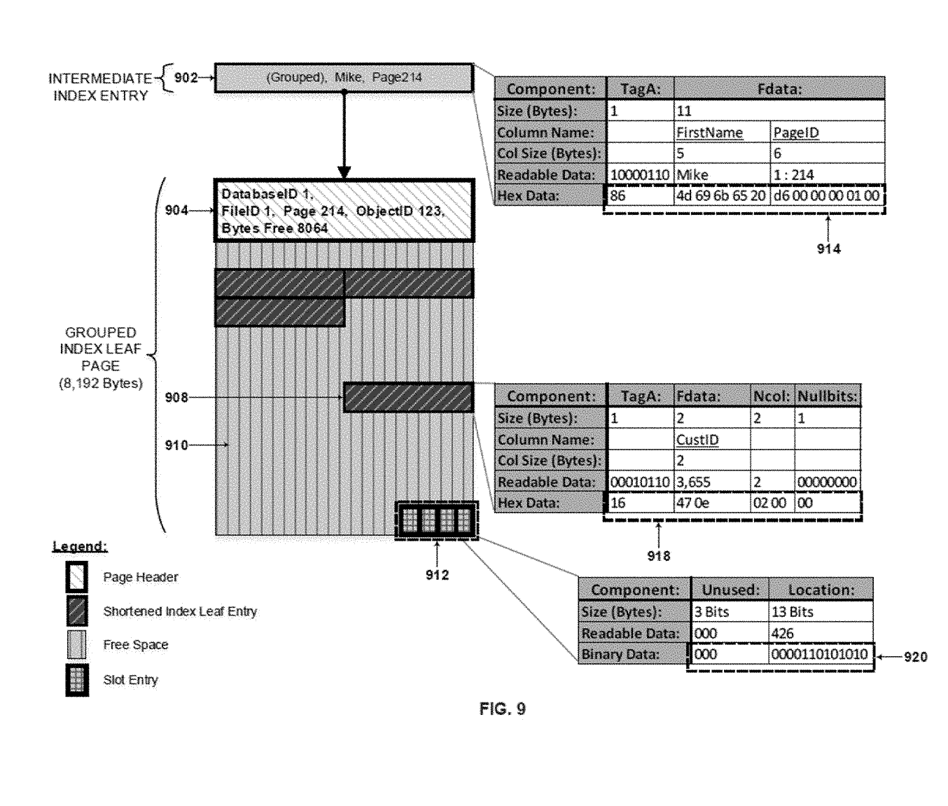

FIG. 9 is an illustration of an exploded view of one embodiment of a grouped index leaf page with an improved intermediate index entry according to the present disclosure. As shown in FIG. 9, the column ‘FirstName’ may be the index key value and ‘CustID’ may be the index leaf pointer. The improved B-Tree index shown in FIG. 9 may also be defined as not allowing NULLs, not having any variable-length columns, and not having any versioning information stored.

The improved B-Tree index illustrated in FIG. 9 may also comprise at least one intermediate index entry 902 and at least one grouped index leaf page having a size of 8,192 bytes.

The intermediate index entry 902 may comprise several components including a TagA component, a Fdata component, and optionally other components. The intermediate index entry 902 may comprise optional additional components.

The TagA component of the intermediate index entry 902 may be 1 byte in size and may store various statuses of the intermediate index entry 902. The TagA component may provide a status means for determining various statuses. The TagA component of the intermediate index entry 902 may be an improved. TagA component that may be extended to include a 1 bit status for determining the index leaf page type of the grouped index leaf page and that the intermediate index entry 902 references. Also, as shown in FIG. 9, the TagA component of the intermediate index entry 902 may be modified from ‘00000110’ to ‘10000110’ with the first bit indicating that the index leaf page ‘1:214’ may be of the grouped index leaf page type.

The Fdata component of the intermediate index entry 902 may have a size that is the sum of the size of all the fixed-length columns for the index entry, and it may store the fixed-length columns of the index entry. In the improved B-Tree index illustrated in FIG. 9, the Fdata component of the intermediate index entry 902 may be 11 bytes in size. The intermediate index entry 902 may be stored as HEX format in little-endian encoding 914 (white space is for illustration only) on the data storage device.

In the grouped index leaf page of the improved B-Tree index illustrated in FIG. 9, the grouped index leaf page may comprise one page header 904 having a size of 96 bytes, at least one shortened index leaf entry 908, optionally some free space 910, and optionally a slot array 912.

The shortened index leaf entry 908 may comprise several components including a TagA component, a Fdata component, and optionally other components. The shortened index leaf entry 908 may comprise the index leaf pointer, and in this grouped index leaf page ‘CustID’.

The TagA component of the shortened index leaf entry 908 may be 1 byte in size and may store various statuses of the shortened index leaf entry 908.

The Fdata component of the shortened index leaf entry 908 may have a size that may be the sum of the size of all the fixed-length columns of the index leaf pointer, and it may store the fixed-length columns of the index leaf pointer. The Fdata component of the shortened index leaf entry 908 may vary in size depending on: (1) how many columns of the index leaf pointer are fixed-length data types and (2) the defined size of each fixed-length column of the index leaf pointer. In the grouped index leaf page of the improved B-Tree index illustrated in FIG. 9, the Fdata component of the shortened index leaf entry 908 may be 2 bytes in size. The shortened index leaf entry 908 may be stored as HEX format in little-endian encoding 918 (white space is for illustration only) on the data storage device.

The slot array 912 may contain one slot entry for each shortened index leaf entry on the grouped index leaf page. The slot array 912 may track the location and logical order of all the shortened index leaf entries on the grouped index leaf page. The slot entries may be stored as HEX format in little-endian encoding on the data storage device, shown in FIG. 9 as binary data in big-endian encoding 920 (white space is for illustration only). For the slot entry 920, the binary data shown in FIG. 9 may be stored as the HEX data ‘AA01’.

### Comparison to Existing Compression Technologies

Comparing the improved B-Tree index of the present disclosure to existing compression technologies illustrates the advantages of the embodiments disclosed herein. For an exact comparison, all the compared indexes are for the exemplary index ‘ix_Customer_FirstName’ with the same columns of index data as detailed in FIG. 7 without the optional Ncol and Nullbits components of the index leaf entries. The index ‘ix_Customer_FirstName’ may be defined as not allowing NULLs, not having any variable-length columns, and not having any versioning information stored. For the comparison, the test data of all index entries have ‘FirstName’=‘Mike’ and a random distribution of values for ‘CustID’.

For the given index ‘ix_Customer_FirstName’, the conventional index leaf pages detailed in FIG. 7 will store a maximum of 809 entries per conventional index leaf page. This maximum holds true for all conventional index leaf pages of the index ‘ix_Customer_FirstName’.

For the given index ‘ix_Customer_FirstName’, compressed conventional index leaf pages will store a maximum of 1,154 entries per compressed conventional index leaf page. This maximum value varies and may decrease depending on the actual ‘CustID’ data and how much each entry can be compressed.

For the given index ‘ix_Customer_FirstName’, the grouped index leaf pages according to the present disclosure and detailed in FIG. 9 will store a maximum of 1,619 entries per grouped index leaf page. This maximum holds true for all grouped index leaf pages of the index ‘ix_Customer_FirstName’. In addition, the grouped index leaf pages may have compression applied to them after having been grouped to further reduce their size.

### Method of Modifying an Improved Hybrid B-Tree Index

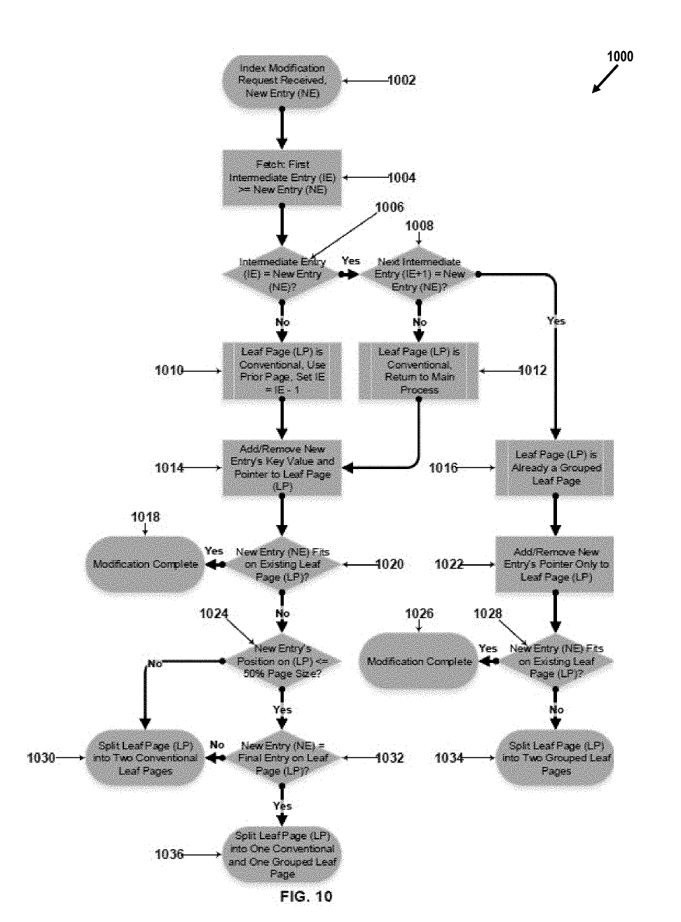

FIG. 10 illustrates a flow chart of one embodiment of a method of adding or removing index entries to an improved hybrid B-Tree index in accordance with the present disclosure. As shown in the flow chart in FIG. 10, block 1002 may represent the first step of the method 1000. As input to start the process, block 1002 may receive a new index entry (NE) which may be the new index data to be added or removed. New index entry (NE) may comprise an index key value and an index leaf pointer and may be the index data that has been requested to be added to or removed from the index. The method 1000 may then proceed to step 1004.

At step 1004, the root index page and intermediate index pages of the index may be scanned, starting from the beginning, to search for the first intermediate index entry (IE) that is greater than or equal to new index entry (NE). During step 1004, the scanning may begin at the first root index entry and may search the root index page and intermediate index pages and may end until it locates the first intermediate index entry (IE) that is greater than or equal to new index entry (NE). In some embodiments of the indexes, there may be no intermediate index pages, and thus, the root index page may serve the function of the intermediate index pages. There may be four outputs from step 1004: (1) first intermediate index entry (IE), (2) intermediate index page (IP) where the first intermediate index entry was found, (3) prior intermediate index entry (IE−1), and (4) next intermediate index entry (IE+1).

The following pseudocode provides one embodiment of a scan of an index to search for the first intermediate index entry (IE) that is greater than or equal to new index entry (NE):

for (currentIE = 0; currentIE <= lastIE; currentIE++)

{if (dBindex[currentIE] >= NE[0])

{IE = currentIE;
break;}

The method 1000 may then proceed to step 1006. Within step 1006, the first intermediate index entry (IE) may be compared to new index entry (NE) to determine whether the first intermediate index entry (IE) and new index entry (NE) are equal. Step 1006 may be optimized and merged with step 1004 into a single operation if the computer programming language in use supports the merge. If first intermediate index entry (IE) is equal to new index entry (NE), then the method 1000 may continue to step 1008. On the other hand, if the first intermediate index entry (IE) and new index entry (NE) are not equal, then the method 1000 may continue to step 1010.

Within step 1008, next intermediate index entry (IE+1) may be compared to new index entry (NE). Next intermediate index entry (IE+1) may have been retrieved earlier in step 1004. If next intermediate index entry (IE+1) is equal to new index entry (NE), then the method 1000 may continue to step 1016, if next intermediate index entry (IE+1) and new index entry (NE) are not equal, then the method 1000 may continue to step 1012 and may return to the main process.

The following pseudocode provides one embodiment of a comparison of next intermediate index entry (denoted IE1 in the following pseudocode) to new index entry (NE):

if (IE1[0] == NE[0])

{leafPageType = “grouped”;
nextStep = 1016;}

else

{leafPageType = “conventional”;
nextStep = 1012;}

Continuing at step 1016, at this step in the method 1000, the type of index leaf page that needs to be modified may have been determined to be a grouped index leaf page. This determination may have been made without accessing, reading, or examining any index leaf pages. Step 1016 may then continue to step 1022. At step 1022, index leaf page (LP) may be fetched from the first intermediate index entry's intermediate index pointer. Index leaf page (LP) may then be modified to add or remove the new index entry's index leaf pointer. The method 1000 may then continue to step 1028. Step 1028 determines whether the new index entry's index leaf pointer may fit on index leaf page (LP) without exceeding the selected maximum index leaf page size. If the new index entry's index leaf pointer does not fit on index leaf page (LP), then the method 1000 may continue to step 1034. On the other hand, if the new index entry's index leaf pointer will fit on index leaf page (LP), then the method 1000 may continue to step 1026, which may complete the method 1000 and may provide an output of the modified index leaf page (LP).

Within step 1034, index leaf page (LP) may be split into two index leaf pages of unequal size by keeping index leaf page (LP) as-is and moving just new index entry (NE) to a new prior index leaf page (LP−1). Both index leaf page (LP) and new prior index leaf page (LP−1) may be the grouped index leaf page type. Intermediate index page (IP) may be modified to add an intermediate index entry that references new prior index leaf page (LP−1). The intermediate index entry for (LP−1) may be added just prior to intermediate index entry (IE). Intermediate index page (IP) may be split as needed if it overflows from the addition of the intermediate index entry for (LP−1). Additional operations that are required to maintain the index may also be performed in step 1034 (e.g., if the index leaf pages also comprises a pointer to the next index leaf page, then said pointer may also be updated to refer to new prior index leaf page). Step 1034 may then complete the method 1000 and may then output the modified pages. There may be three outputs from step 1034: (1) modified index leaf page (LP), (2) new prior index leaf page (LP−1), and (3) modified intermediate index page (IP).

The following pseudocode provides one embodiment of a page split of step 1034 creating unequal page sizes:

leafPageGrouped LP_1 = new leafPageGrouped( );
LP_1.addIndexEntryGrouped(NE[1]);
LP = originalLP;
IP.addIntermediateEntry(LP_1);

Returning to describe steps 1010 and 1012, these steps may follow step 1006 and step 1008, respectively. In step 1006, if first intermediate index entry (IE) is not equal to new index entry (NE), then the method 1000 may continue to step 1010 and thereafter may continue to step 1014. Step 1010 may set intermediate index entry (IE) to the prior intermediate index entry because, in this case, the prior intermediate index entry may reference the index leaf page that needs to be modified. In step 1008, if next intermediate index entry (IE+1) is not equal to new index entry (NE), then the method 1000 may continue to step 1012 and thereafter may continue to step 1014. At step 1010 and step 1012 in the method 1000, the type of index leaf page that needs to be modified may have been determined to be a conventional index leaf page type. This determination may have been made without accessing, reading, or examining any index leaf pages.

Continuing to step 1014, which may fetch index leaf page (LP) from the first intermediate index entry's intermediate index pointer, step 1014 may scan the index leaf page (LP), starting from the beginning, to search for the first conventional index leaf entry that is greater than or equal to new index entry (NE). Index leaf page (LP) may then be modified to add or remove the new index entry's index key value and index leaf pointer. The method 1000 may then continue to step 1020. Step 1020 determines if new index entry (NE) may fit on index leaf page (LP) without exceeding the selected maximum index leaf page size. If new index entry (NE) does not fit on index leaf page (LP), then the method 1000 may continue to step 1024. On the other hand, if new index entry (NE) will fit on index leaf page (LP), then the method 1000 may continue to step 1018. Step 1018 then may complete the method 1000 and may output modified index leaf page (LP).

The following pseudocode provides one embodiment of adding new index entry (NE) to index leaf page (LP) and determining if new index entry (NE) will fit on index leaf page (LP):

LP.addIndexEntryConventional(NE[0], NE[1]);
if (LP.length( ) <= maximumPageSize)

{nextStep = 1024;}

else

{nextStep = 1018;}

Continuing at step 1024, step 1024 determines whether the new index entry's position on index leaf page (LP) is less than or equal to fifty percent of the selected maximum index leaf page size. If the new index entry's position on index leaf page (LP) is less than or equal to fifty percent of the maximum index leaf page size, then the method 1000 may continue to step 1032. On the other, if the new index entry's position on index leaf page (LP) is greater than fifty percent of the maximum index leaf page size, then the method 1000 may continue to step 1030.

The following pseudocode provides one embodiment of determining the new index entry's position on index leaf page (LP):

if (LP.indexOf(NE[0]) > maximumPageSize / 2)

{nextStep = 1030;}

else

{nextStep = 1018;}

Within step 1030, index leaf page (LP) may be split into two conventional index leaf pages of about equal size by moving the first half of conventional index leaf entries from index leaf page (LP) to new prior index leaf page (LP−1). As an optimization, step 1030 may split index leaf page (LP) at a position where there are dissimilar index key values (i.e., index leaf entries with the same index key value are generally not split into two separate index leaf pages). This optimization to the page split process may be advantageous, as it may create additional locations in the index that could subsequently be converted to grouped index leaf page types. This optimization may also allow the method 1000 to predict which index leaf pages are conventional and which index leaf pages are grouped based on the intermediate index entries.

The following pseudocode provides one embodiment of a page split of step 1030 on index leaf page (LP):

leafPageConventional LP_1 = new leafPageConventional( );
int splitLocation = 0;
for (currentLocation = maximumPageSize / 2; currentLocation <=
maximumPageSize; currentLocation++)

{if (LP.substring(currentLocation,
−1).indexOf(NextKeyValue).Value[1] <>

LP.substring(currentLocation + 1, −1).indexOf(NextKeyValue).Value[1]

{splitLocation = currentLocation;
break;}}

LP_1 = LP.substring(1, splitLocation − 1);
LP = LP.substring(splitLocation, −1);

In step 1030, both index leaf page (LP) and new prior index leaf page (LP−1) may be conventional index leaf page types. Step 1030 may modify intermediate index page (IP) to add an intermediate index entry that references (LP−1). The intermediate index entry for (LP−1) may be added just prior to intermediate index entry (IE). Intermediate index page (IP) may be split as needed if it overflows from the addition of the intermediate index entry for (LP−1). Additional operations that are required to maintain the index may also be performed in step 1030 (e.g., if the index leaf pages also comprises a pointer to the next index leaf page, then said pointer may also be updated to refer to new prior index leaf page). Step 1030 may then complete the process and may output the modified pages. There may be three outputs from step 1030: (1) modified index leaf page (LP), (2) new prior index leaf page (LP−1), and (3) modified intermediate index page (IP).

Within step 1032, the method 1000 may then compare new index entry (NE) to the final entry on index leaf page (LP). Step 1032 may scan index leaf page (LP), starting from the end, to search for the final conventional index leaf entry on index leaf page (LP). If new index entry (NE) is equal to the final conventional index leaf entry on index leaf page (LP), then the process may continue to step 1036. On the other hand, if new index entry (NE) is not equal to the final conventional index leaf entry, then the method 1000 may continue to step 1030 as described above.

Within step 1036, index leaf page (LP) may be split into two index leaf pages of unequal size by moving new index entry (NE) and all conventional index leaf entries subsequent to (NE) to new index leaf page (LP+1). Index leaf page (LP) may remain a conventional index leaf page type, and new index leaf page (LP+1) may be built as a grouped index leaf page type by moving the index leaf pointers subsequent to (NE) to (LP+1). Intermediate index page (IP) may then be modified to add an intermediate index entry that references new index leaf page (LP+1). The intermediate index entry for (LP+1) may be added just subsequent to intermediate index entry (IE). Intermediate index page (IP) may be split as needed if intermediate index page (IP) overflows from the addition of the intermediate index entry for (LP+1). Additional operations that are required to maintain the index may also be performed in step 1036 (e.g., if the index leaf pages also comprises a pointer to the next index leaf page, then said pointer may also be updated to refer to new index leaf page). Step 1036 may then complete the method 1000 and may output the modified pages. There may be three outputs from step 1036: (1) modified index leaf page (LP), (2) new index leaf page (LP+1), and (3) modified intermediate index page (IP).

The following pseudocode provides one embodiment of a page split of step 1036 on index leaf page (LP):

leafPageGrouped LP1 = new leafPageGrouped( );
int splitLocation = LP.indexOf(NE[0]);
LP1 = LP1.convertToGrouped(LP.substring(splitLocation, −1));
LP = LP.substring(0, splitLocation − 1);

### CONCLUSION

This concludes the description of the various embodiments. The following describes some alternative embodiments for accomplishing the above of the present disclosure. For example, various types of computers, such as a mainframe, minicomputer, or personal computer, or computer configuration, including without limitation a timesharing mainframe, local area network, or standalone personal computer, may be used.

In summary, the present specification discloses a method and apparatus for computer-implemented indexes with grouped index leaf pages. The above description of the various embodiments has been presented for the purposes of illustration and description. It is not intended to be exhaustive or to limit the disclosure to the precise form disclosed. Many modifications and variations are possible in light of the above teaching. It is intended that the scope of the disclosure be limited not by this detailed description, but rather by the claims appended hereto.

What is claimed:

1. A computer-implemented B-Tree index structure for storing at least one column of index data as a logically ordered set of index entries on a data storage device, comprising:
a. at least one first intermediate index entry, comprising:
i. a first intermediate index key value of one or more columns of index data; and
ii. a first intermediate index pointer;
b. at least one grouped index leaf page, comprising:
i. at least one shortened index leaf entry, having a first grouped index key value of said one or more columns of index data of said at least one shortened index leaf entry selectively extracted; comprising:
i. an index leaf pointer;
ii. wherein said index leaf pointer references a source of an index data; and
ii. a page header, comprising;
i. a page header index key value of said one or more columns of index data;
ii. wherein said page header index key value of said page header stores said extracted first grouped index key value from said at least one shortened index leaf entry;
c. wherein said first intermediate index pointer references said at least one grouped index leaf page; and
d. wherein said at least one grouped index leaf page stores a plurality of index leaf pointers that correspond to a plurality of index entries of a same index key value of said one or more columns of index data.

2. The B-Tree index structure of claim 1, wherein said page header further comprises:
at least one status means for indicating an index leaf page type of said at least one grouped index leaf page.

3. The B-Tree index structure of claim 1, wherein said at least one shortened index leaf entry further comprises:
at least one status means for indicating an index leaf entry type of said at east one shortened index leaf entry.

4. The B-Tree index structure of claim 1, wherein said at least one grouped index leaf page further comprises:
a slot array for storing one or more locations of one or more shortened index leaf entries on said at least one grouped index leaf page, comprising:
i. at least one byte location pointer;
ii. at least one status means for indicating an index leaf entry type of said at east one shortened index leaf entry;
iii. wherein said byte location pointer references a location of said shortened index leaf entry on said at least one grouped index leaf page.

5. The B-Tree index structure of claim 1, wherein said at least one first intermediate index entry further comprises:
at least one status means for indicating an index leaf page type of said at least one referenced grouped index leaf page.

6. The B-Tree index structure of claim 1, wherein said first intermediate index key value of said at least one first intermediate index entry comprises: a first segment and a second segment;
wherein said first segment is defined as an index key value prefix and stored in said at least one first intermediate index entry; and
wherein said second segment is absent from said at least one first intermediate index entry.

7. The B-Tree index structure of claim 1, wherein said B-Tree index is a composite index;
wherein said composite index comprises one or more composite index key values;
wherein each of said one or more composite index key values comprises a plurality of columns of index data; and
wherein each column of said plurality of index data stores a category of information.

8. The B-Tree index structure of claim 1, further comprising:
a. at least one second intermediate index entry comprising:
i. a second intermediate index key value of said one or more columns of index data; and
ii. a second intermediate index pointer;
b. at least one conventional index leaf page, comprising:
i. at least one conventional index leaf entry, comprising:
i. a conventional index key value of said one or more columns said index data; and
ii. a conventional index leaf pointer;
iii. wherein said conventional index leaf pointer references a source of said index data;
wherein said second intermediate index pointer references said at least one conventional index leaf page.

9. The B-Tree index structure of claim 1, wherein said at least one shortened index leaf entry, is a partially shortened index leaf entry, further comprising:
a partially shortened index key value of said one or more columns of index data.

10. The B-Tree index structure of claim 8, wherein said B-Tree index is a composite index;
wherein said composite index comprises one or more composite index key values;
wherein each of said one or more composite index key values comprises said one or more columns of index data;
wherein each of said one or more columns of index data stores a category of information.

11. The B-Tree index structure of claim 8, wherein said at least one shortened index leaf entry is a partially shortened index leaf entry, comprising:
a partially shortened index key value of said one or more columns of said index data.

12. A computer-implemented B-Tree index structure for storing at least one column of index data as a logically ordered set of index entries on a data storage device, comprising:
a. at least one first intermediate index entry comprising;
i. a first intermediate index key value of one or more columns of an index data; and
ii. a first intermediate index pointer;
b. at least one grouped index leaf page comprising;
i. at least one shortened index leaf entry, having a grouped index key value of said one or more columns of index data of said shortened index leaf entry extracted, comprising;
i. an index leaf pointer;
ii. wherein said index leaf pointer references a source of said index data;
c. wherein said at least one first intermediate index entry stores said extracted group index key value from said at least one shortened index leaf entry, and said at least one grouped index leaf page stores a plurality of index leaf pointers that correspond to a plurality of index entries of a same index key value of said one or more columns of said index data; and
d. wherein said first intermediate index pointer references said at least one grouped index leaf page.

13. The B-Tree index structure of claim 12, wherein said at least one grouped index leaf page further comprises:
a page header, comprising at least one status means for indicating an index leaf page type of said at least one grouped index leaf page.

14. The B-Tree index structure of claim 12, wherein said at east one shortened index leaf entry further comprises:
at least one status means for indicating an index leaf entry type of said at least one shortened index leaf entry.

15. The B-Tree index structure of claim 12, wherein said at least one grouped index leaf page further comprises:
a slot array for storing one or more locations of one or more shortened index leaf entries on said at least one grouped index leaf page, comprising;
i. at least one byte location pointer;
ii. at least one status means for indicating an index leaf entry type of said at least one shortened index leaf entry; and
iii. wherein said byte location pointer references a location of said at least one shortened index leaf entry on said at least one grouped index leaf page.

16. The B-Tree index structure of claim 12, wherein said at east one first intermediate index entry further comprises:
at least one status means for indicating an index leaf page type of said at least one referenced grouped index leaf page.

17. The B-Tree index structure of claim 12, wherein said B-Tree index is a composite index;
wherein said composite index comprises one or more composite index key values;
wherein each of said one or more composite index key values comprises a plurality of columns of said index data; and
wherein each of said plurality of columns of said index data stores a category of information.

18. The B-Tree index structure of claim 12, further comprising:
a. at least one second intermediate index entry comprising;
i. a second intermediate index key value of one or more columns of said index data; and
ii. a second intermediate index pointer; and
iii. wherein said second intermediate index pointer references one conventional index leaf page;
b. at least one conventional index leaf page, comprising
i. a conventional index key value of said one or more columns of said index data; and
ii. a conventional index leaf pointer; and
iii. wherein said conventional index leaf pointer references a source of said index data.

19. The B-Tree index structure of claim 12, wherein said at least one shortened index leaf entry is a partially shortened index leaf entry, further comprising:
a partially shortened index key value of said one or more columns of said index data.

20. A method of modifying a computer-implemented B-Tree index, comprising the steps:
a. scanning one or more intermediate index pages for a first intermediate index entry greater than or equal to a new index entry;
b. comparing said first intermediate index entry to said new index entry for equality;
c. comparing a second intermediate index entry to said new index entry for equality to determine whether an index leaf page type is a grouped index leaf page;
d. fetching an index leaf page from an intermediate index pointer of said first intermediate index entry and adding or removing an index leaf pointer of said new index entry;
e. determining whether said index leaf pointer of said new index entry will fit on said index leaf page;
f. splitting said index leaf page into two grouped index leaf pages of unequal size;
g. setting said second intermediate index entry to said first intermediate index entry;
h. determining said index leaf page type to be a conventional index leaf page type, and return to a main process;
i. fetching said index leaf page from said intermediate index pointer of said first intermediate index entry, and adding or removing said index key value of said new index entry and said index leaf pointer to a leaf page;
j. determining whether said new index entry will fit on an index leaf page without exceeding a selected maximum index leaf page size;
k. determine if a position of said new index entry on said index leaf page is less than or equal to fifty percent of a selected maximum index leaf page size;
l. splitting said index leaf page into two conventional index leaf pages;
m. comparing said new index entry to a final entry on said index leaf page; and
n. splitting said index leaf page into two index leaf pages with said index leaf page remaining a conventional index leaf page type and said new index leaf page built as a grouped index leaf page type.
